(19) United States
(12) Patent Application Publication
(10) Pub. No.: US 2009/0262352 A1
(43) Pub. Date: Oct. 22, 2009

(54) Device for the optical detection of the lateral position of characteristics on traveling material webs and method for operating this device

(76) Inventors: Frank Trilling, Hanau (DE); Peter Kespohl, Kelkheim (DE)

Correspondence Address: DUNLAP CODDING, P.C., PO BOX 16370, OKLAHOMA CITY, OK, 73113, US

(21) Appl. No.: 12/231,358

(22) Filed: Sep. 2, 2008

(30) Foreign Application Priority Data
Apr. 19, 2008 (EP) 08007671

(51) Int. Cl. G01N 21/86

(52) U.S. Cl. 356/429

(57) ABSTRACT

The device for the optical detection of the lateral position of features on the surface of traveling material webs has an optical imaging system including an objective lens (14) and light-sensitive receiver elements (16) arranged in a line and two illumination devices for illuminating the detection area (7), the first (20) of which is arranged in such a way that light beams of variable color emitted by it do not arrive at the imaging system by mirror reflection, while the second is composed of a punctiform light source (10) and a focusing lens (12; 13) that are arranged and disposed in such a way that beams emitted by it converge after mirror reflection on the detection area (7) in the lens (14) of the imaging system.

### CROSS-REFERENCE TO RELATED APPLICATIONS

The present patent application claims priority to the European patent application identified by Serial No. 08007671, filed Apr. 19, 2008, the entire content of which is hereby incorporated herein by reference.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

Reference to a “Sequence Listing,” a table, or a computer program listing appendix submitted on a compact disc and an incorporation-by-reference of the material on the compact disc (see §1.52(e)(5)). The total number of compact discs including duplicates and the files on each compact disc shall be specified.

Not Applicable.

### BACKGROUND OF THE INVENTION

The invention relates to a device for the optical detection of characteristics on traveling material webs and methods for making and operating this device.

Devices of this type are used in industry for the purpose of controlling the lateral position of traveling material webs in such a way that the detected characteristic of the material web is kept at a desired lateral position, even when disruptive influences are acting on the material web. Control circuits that perform this function are known per se and have been described often. An early form is described in U.S. Pat. No. 3,431,425 (1969).

In order to meet the increasing demands of the processing industry, these control circuits are continuously developed over time. In particular, the optical sensor for the detection of the control characteristic was also the goal of continuous development so as to be able to use even difficult to detect characteristics for the lateral regulation of material webs. In the case of printed material webs, characteristics in the sense used here could be parts of a printed image; however, differences in the color of the material web itself, or partial coatings on the surface of the material web should often be used as a characteristic for the purpose of regulating the position of the material web.

This type of optical sensors normally includes one or more light sources, one or more light-sensitive receiver elements, elements for forming light beams, such as, for example, lenses, apertures, and mirrors, and electronic elements for processing the output signals of the light-sensitive receiver elements. If necessary, keys and display elements may also be present for operating the sensor. Today, integrated CMOS or CCD circuits are used as light-sensitive receiver elements in which a plurality of these receiver elements are combined on a semiconductor crystal and that are preferably arranged in lines for the application discussed here. In conjunction with the imaging optical elements of such a sensor, this results in a linear scanning area on the surface of the material web that is preferably arranged orthogonally to the direction of movement of the material web.

On the one hand, as already recited in U.S. Pat. No. 3,431,425, the characteristics to be detected may be linear characteristics or repeating patterns such as, for example, bar codes, which are often printed on packaging material. Other unambiguously recognizable patterns may also be used as control characteristics with the image processing methods available today. The edge of the material web itself relative to a support roll may also result in a corresponding contrast and then be used as a characteristic for position regulation.

Moreover, devices are in demand that react to characteristics that arise from the fact that sections of the surface differ from neighboring regions in terms of glossiness. For example, on drug packaging whose glossy coating cannot be easily written on by pencils, ballpoint pens, or markers, a small field of the coating is omitted in order to allow information such as dosage instructions to be written in by hand. These matte fields do not differ from the surrounding areas in terms of their color or brightness, but rather only in terms of their reflective behavior.

Differences in glossiness of the type discussed above may also exist, for example, at the border between a glossy coating and uncoated, non-glossy material. However, the same thing may also result from partial mechanical surface finishing or other forms of surface finishing. It is also sometimes the case that the edge of a glossy, transparent material surface may be used to contrast with a non-glossy or less glossy support roll or with another background for the purpose of position regulation. One recurring goal is to use a color-based characteristic for one production run and a gloss-based characteristic for another production run, both at the very same point in a system.

DE 36 37 874 A1 (1988) describes a device that allows the edge of a glossy, transparent material surface to be scanned relative to a less glossy background. In DE 100 22 597 (2001), a complete sensor for both tasks is described, namely, first the scanning of gloss-based characteristics and second the scanning of color-based characteristics; here, light sources dedicated to both tasks are provided for the scanning area, which are alternatively and cumulatively activated.

U.S. Pat. No. 6,566,670 (2003) also describes such a combination device. In all three devices mentioned above, a flat, diffuse light source is used for illuminating the glossy surface that essentially comprises a diffusing screen that is illuminated from behind.

It has now been shown that devices of the type mentioned above do not result in a good contrast between glossy and non-glossy surfaces if the non-glossy surface is a light color or white without any additional color. This effect is caused by the diffuse light source. In the case of a diffuse light source, light beams are emitted from its surface in all directions. Only a small portion of these light beams has the correct angle when it strikes the glossy surface to arrive at the receiver elements under the mirror rule of angle of incidence=angle of reflection. A substantially greater portion of the beams from the diffuse light source does not reach the receiver elements after being reflected by the glossy surface. However, if the non-glossy surface is located in the field of the sensor rather than the glossy surface, then all of the light beams from the diffuse light source that strike the field of the sensor cause the material web to be illuminated. This explains the small difference in contrast in the case discussed above.

Similar problems exist for printed material webs that are additionally partially coated with a transparent layer. The printed image located below the transparent layer reflects al light beams of the diffuse light source corresponding to the printing ink used, while the transparent layer again reflects only those light beams that fulfill the mirror rule back to the receiver elements. This disrupts the certain recognition of the border between coated and non-coated sections of the surface because parts of the printed image shine through the transparent coating and they are not covered sufficiently by the reflection of the light on the transparent coating.

### BRIEF SUMMARY OF THE INVENTION

The object of the invention is therefore to create an optical combination sensor that may be switched, on the one hand, to scan color-based characteristics, even if they are located below a transparent, glossy coating and, on the other hand, may be used to reliably detect characteristics that are present as differences in glossiness on the surface of a material web, even if they are present on pale backgrounds or printed material webs.

The manner of attaining this object is described in the Claims.

The second illumination device to be used for the detection of gloss-based characteristics is formed by a light source that is as punctiform as possible and an optical condenser. A monochromatic light diode may be considered as a punctiform light source because, on the one hand, the light-emitting surface of such a light diode is very small and thus approximates a punctiform light source very well and, on the other hand, because the color of the light (wavelength) plays a rather subordinate role in light reflection on glossy surfaces. Another possibility is the use of an aperture with a correspondingly small light exit opening.

The maximum diameter of the light diode or an aperture depends on the minimum resolution required by the receiver and the parameters of directed lighting. In a concrete embodiment with regard to number and arrangement of the lenses, size of the aperture, and other relevant parameters, in the case of a certain resolution requirement, for the size of the light-sensitive receiver element being 12.5 μm, a length of the detection area (extending at a right angle to the travel direction of the material) of 30 mm and a required resolution of approximately 125 lines, a maximum diameter of the light source of 1 mm results is calculated.

Now, if the optical geometry, namely the distance between the punctiform light source and the condenser (which should be viewed as the preferred example of focusing optics), the focal length of the condenser, the focal length of the condensing lens(es), and the total of the distances between the condenser and the detection area as well as between the detection area and the lens of the imaging system is selected in accordance with Claim 1, this ensures that all beams reflected by the material web in the detection area also arrive at the receiving elements.

### BRIEF DESCRIPTION OF THE SEVERAL VIEWS OF THE DRAWING

The invention shall be described in greater detail in the following by the description of exemplary embodiments with reference to the attached drawings, which show:

FIG. 1 a schematic top view, a side view, and a cross-sectional view of a section of a traveling material web that has been partially printed with color-based characteristics and partially coated with a glossy coating;

FIG. 2 a schematic view of the arrangement of the component groups of a device according to the invention

FIG. 3a the beam path of a light beam striking a completely reflective surface;

FIG. 3b the case of FIG. 3a with a glossy surface;

FIG. 3c the case of FIG. 3a with a matte, i.e., diffusely reflective, surface;

FIG. 4a is a schematic depiction of the parts of the device designated for the detection of glossy elements, with the optically equivalent depiction of the beam path being shown with dashed lines;

FIG. 4b the depiction of FIG. 4a rotated by 90°, in which the material web is traveling into the plane of the drawing;

FIG. 5 the situation according to the prior art;

FIG. 6 the beam paths when the light sources are placed in a common housing and a concave mirror strip as the focusing optical element;

FIG. 7a schematic view of a device with all essential component groups;

FIG. 8 a schematic view of the structure of the device from a signal technology standpoint.

### DETAILED DESCRIPTION OF THE INVENTION

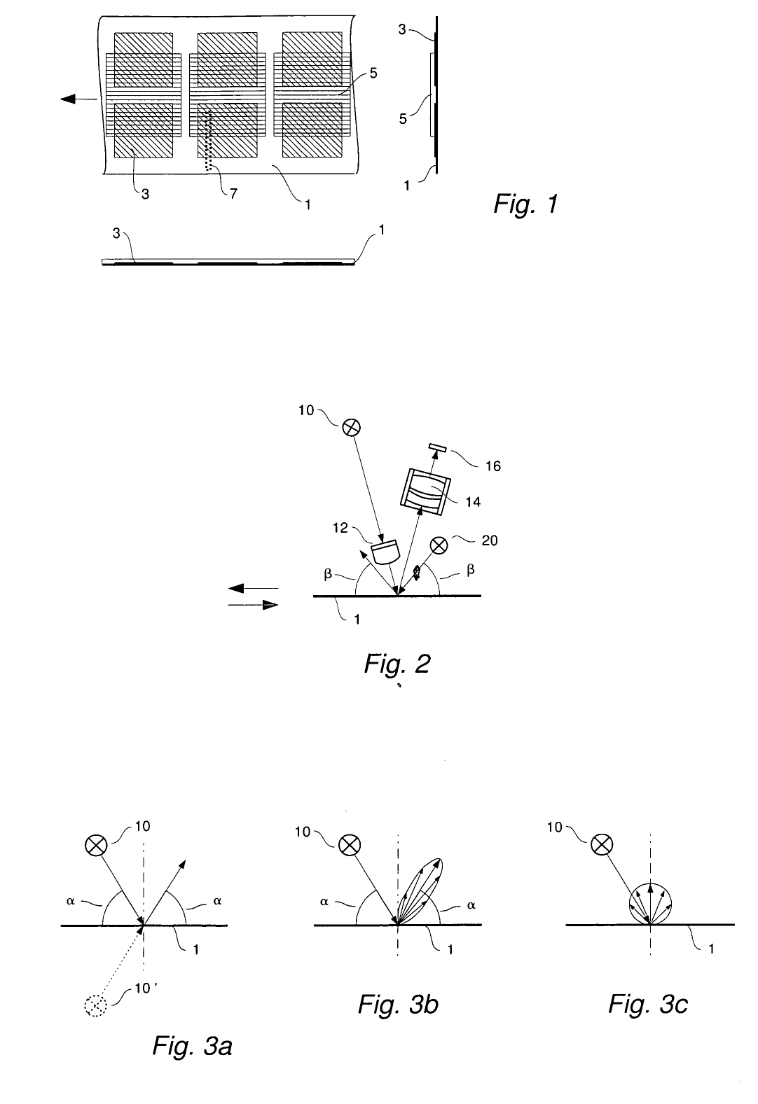

The section of a material web to be scanned shown in FIG. 1, which is shown only by way of example and is not to scale, is composed of the material web 1, which is traveling in the direction of the arrow, on which patterns 3, depicted as diagonally striped squares, have been printed. Other regions have been provided with a transparent, glossy coating 5, with these regions, which are striped in the web travel direction, partially overlapping with the patterns 3. Moreover, 7 is used to indicate the detection area on the material web that is evaluated by the optical sensor in a cyclically repeating manner. The different combinations of printed image and glossy coating travel through the detection area in a manner corresponding to the web speed.

FIG. 2 shows a schematic depiction of the components of a device according to the invention. Above the material web 1, which is traveling in the direction of the arrows, an optical imaging system is arranged including an object lens 14 and receiver elements 16, with the object lens 14 mapping the image of the material web in the detection area 7 on the receiver elements 16. The imaging system is inclined towards the material web 1 relative to the perpendicular; its ray forms an angle α relative to the material web.

In order to illuminate the material web 1, which is traveling in the direction of the arrows, in the detection area, there is a first illumination device 20 located on the same side as the imaging system and whose light beams strike at a smaller angle β. Insofar as mirror reflection occurs in the detection area, the beams, which reflect at the same angle β, pass far away from the lens 10 of the optical imaging system.

This first illumination device 20 primarily serves to scan color-based characteristics. Only beams of diffuse reflection as shown in FIG. 3c will be able to reach the object lens 14. In order to detect color-based characteristics, the illumination device 20 is composed of multiple light elements having different light colors and being able to be turned on and off individually. Preferably, light diodes are used that emit light of different wavelengths. For sensors intended to differentiate between color-based characteristics in a manner similar to human color sensitivity, light diodes with the colors red, green, and blue are used. For sensors intended to evaluate technical color-based characteristics in other wavelength ranges, differently colored light diodes are added as necessary, for example, including light diodes that emit light in the infrared or UV ranges.

A second illumination device is composed of a punctiform light source 10 and a focusing lens 12 and is preferably located on the other side of the perpendicular at the angle α to the material web 1, such that its beams are directed at the object lens 14 in the case of mirror reflection.

The optical properties of this second illumination device should meet certain conditions, which will be explained by the following considerations:

FIG. 3a shows the behavior of a light beam when it emanates from a light source 10 and strikes a completely reflective material web 1. It is reflected and may be registered by a receiver element only in a direction α. At the position 10′, the mirror image of the light source may be observed. FIG. 3b shows the behavior of the light beam on glossy material webs and FIG. 3c shows the behavior of the light beam on surfaces that reflect exclusively diffusely.

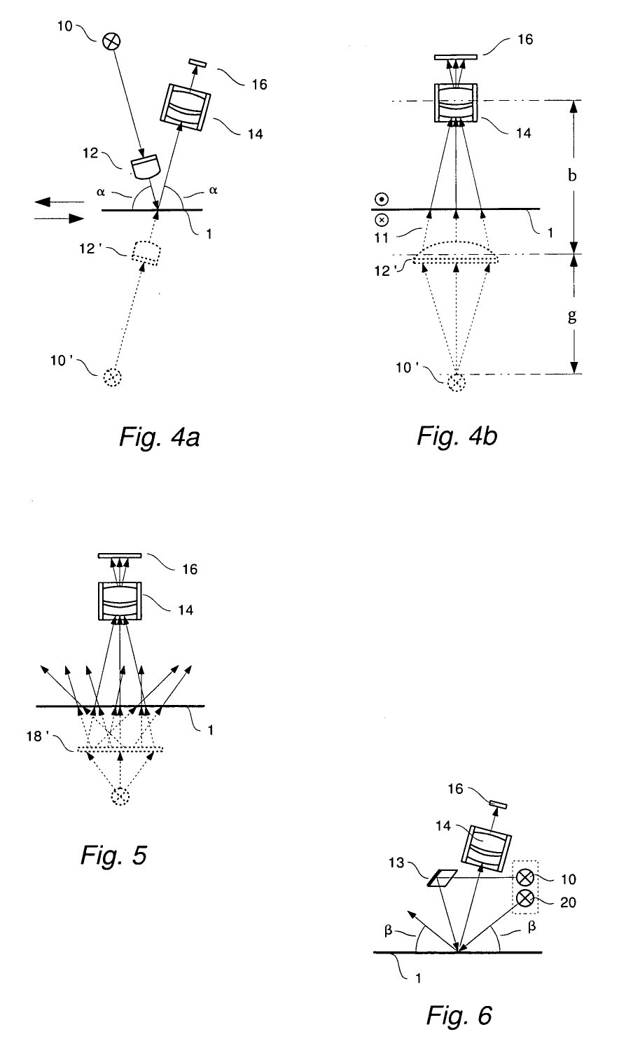

FIG. 4a expands upon the depiction in FIG. 3a with the elements of the optical imaging system and the second illumination device. The mirror images of the approximately punctiform light source 10 and the condenser lens 12 are marked as 10′ and 12′. The beam path of the light source and the imaging lens is disposed relative to the material web such that mirror conditions are adhered to, i.e., such that they are at the same angle (α) to the material web.

FIG. 4b shows the elements of the depiction in FIG. 4a in a view that has been rotated by 90°, with the real elements 10 and 12 being omitted in order to prevent overlapping and with only their mirror images 10′ and 12′ being shown. In addition, the planes of the optical effect that the condenser lens 12′ and the object lens 14 would have as ideal, thin lenses are shown by dot-dash lines. The object distance g and image distance b of the condenser lens 12′ are drawn in as well. This fulfills the condition that the output-side bundle of rays of the condenser lens 12′ and thus a reflected bundle of rays from the real condenser lens 12 reflected by the detection area 7 converge in the object lens 14.

If a normal lens is used, the distance between the imaging system 14/16 and the material web must be kept constant or tolerances must be allowed with regard to the recognition precision. These limitations may be omitted if a special lens is used (which is expensive, however), in particular a telecentric lens, and the focusing lens is adapted to its beam path in the same manner as described above; the advantages of such an arrangement are particularly felt if, during operation of the device, the characteristics of the cyclically scanned images of the detection area are compared to a stored pattern or a learned model, having to do with distances from one color transition to another.

Additionally, FIG. 5 shows in the mirror depiction how, in the known detection devices according to the prior art, instead of the focusing lens 12′, a diffusing screen 18′ is provided from which the light beams are emitted in all directions, such that every point of the material web 1 in the analysis area of the sensor is illuminated from an entire range of angles.

If, therefore, according to the present recommendation, only such light beams strike the analyzed area of the material web as will reach the receiver elements according to the rule of reflection and no additional light beams that do not meet these requirements, then a considerable difference in amplitude will result between glossy and non-glossy portions of the surface. If, on the other hand, as in the prior art, additional light beams were added at other angles, then the non-glossy areas of the material web would be illuminated (or brightened) and the difference in amplitude between glossy and non-glossy portions of the surface would be reduced or would disappear entirely.

The arrangement according to FIG. 6 fulfills the same purpose as the arrangement according to FIG. 2. In this arrangement, the condenser, which is composed of one lens, has been replaced by a concave mirror strip 13, which also focuses the light beams of the punctiform light source 10 and, at the same time, diverts them in such a way that they will strike in accordance with the rule of reflection at the angle of the ray of the imaging lens 14. In this arrangement, the punctiform light source 10 of the second illumination device and the first illumination device 20 may be combined into one unit so that the electrical power supply and heat dissipation may occur centrally in a simpler and more effective fashion.

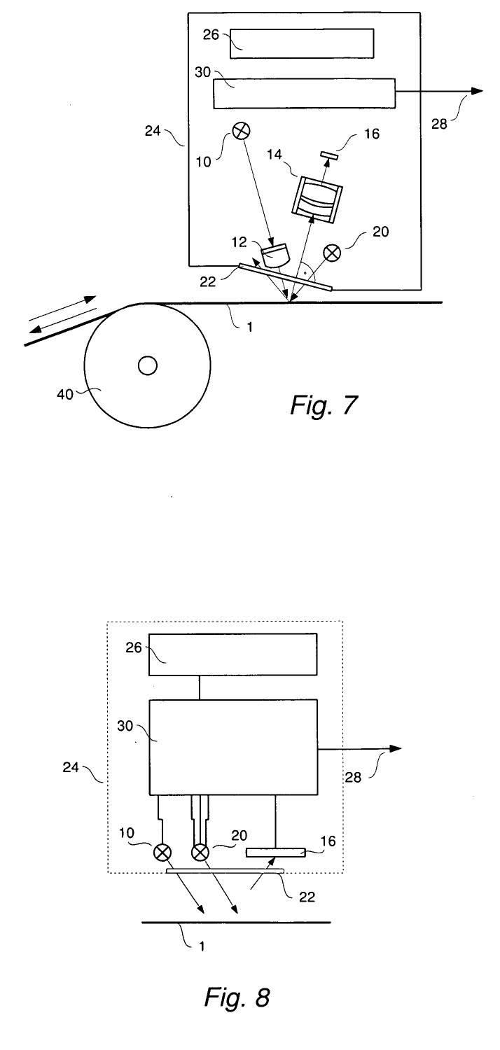

Finally, FIG. 7 schematically shows an overall arrangement with a housing 24 and a transparent disc 22 provided in the wall of the housing. This disc protects the sensor from dust and other harmful environmental influences.

This disc must be arranged in such a way that no light reflection is able to penetrate from its inner surface to the lens 14. Preferably, this disc is arranged at a right angle to the beam path of the lens. The material web is preferably scanned nearby or on a support roll 40 in order to guarantee a stable geometry of the arrangement. A connection for electrical signal exchange with the additional components of a web guidance system has been designated with 28. This signal exchange should preferably be embodied as a digital interface so as to be able to transmit complex information as well. However, in the case of lower requirements, an analog signal exchange may be used as well. In this manner, the signal processing unit 30 located inside the sensor is connected to the other components of the web guidance system. Moreover, a control panel 26 is provided as well.

FIG. 8 shows the connectivity of the individual components of the sensor from a signal technology standpoint. The control panel 26 is connected to the signal processing unit 30. This control panel may be structured with mechanical keys or a keypad and light diodes and/or an LCD display for user prompts. In particular, provision is made for the user to be able to select via this control panel whether color-based characteristics or gloss-based characteristics are to be evaluated by the sensor. An additional operating mode should also allow this selection to be made from outside via the electrical signal exchange 28. Thus, the signal processing unit 30 is made able to select the correct light source 10 or 20. Moreover, the light-sensitive receiver elements 16 are connected to the signal processing unit 30 such that it is able to detect the position of the characteristic(s) and, in the case of color-based characteristics, automatically select the light color for the first illumination device 20 that will produce the highest signal amplitudes at the receiver elements 16 for the detected characteristic.

What is claimed is:

1. An optical device for detecting a lateral position of a traveling material web, comprising:
an optical imaging system, including:
an objective lens; and
a light-sensitive receiver element to receive an image of a detection area on the traveling material web through the objective lens;
a first illumination device comprising a light source, wherein the light source is arranged in such a way that light beams emitted by the first illumination device do not arrive at the optical imaging system by mirror reflection; and
a second illumination device comprising a punctiform light source and a focusing element, wherein the punctiform light source and the focusing element are arranged in such a way that light beams emitted by the second illumination device converge after mirror reflection on the detection area in the objective lens,
wherein the first illumination device and the second illumination device are activated dependent upon a characteristic in the detection area on the traveling material web, and only the second illumination device is activated when the characteristic in the detection area comprises two components that differ in glossiness but not in color.

2. The optical device according to claim 1, wherein the detection area is a strip-shaped area oriented transversely on the traveling material web.

3. The optical device according to claim 1, wherein the focusing element has an image distance equal to a distance between the focusing element and the detection area plus a distance between the detection area and the objective lens.

4. The optical device according to claim 1, wherein the punctiform light source is a monochromatic light diode.

5. The optical device according to claim 1, wherein the punctiform light source comprises a light element and an aperture with a light exit opening.

6. The optical device according to claim 1, wherein the focusing element is a condenser lens.

7. The optical device according to claim 1, wherein the focusing element is a concave mirror strip.

8. The optical device according to claims 7, wherein the light source of the first illumination device and the punctiform light source of the second illumination device are combined into one unit.

9. The optical device according to claim 1, wherein the light source in the first illumination device comprises a plurality of light elements of different wavelength, the light elements capable of being individually activated.

10. A method for operating the optical device according to claim 9 to detect a color-based characteristic, comprising the step of:
activating, according to a program, the light elements of the first illumination device one after the other to emit light beams of different wavelength;
receiving the image of the detection area by the light-sensitive receiver element; and
selectively activating the light elements of the first illumination device to produce a greatest signal deviation at the light-sensitive receiver element.

11. A method for making an optical device for detecting a lateral position of a traveling material web, comprising the step of:
providing an optical imaging system to receive images of a detection area on the traveling material web;
providing a first illumination device comprising a light source, wherein the light source is arranged in such a way that light beams emitted by the first illumination device do not arrive at the optical imaging system by mirror reflection;
providing a second illumination device comprising a punctiform light source and a focusing element, wherein the punctiform light source and the focusing element are arranged in such a way that light beams emitted by the second illumination device converge after mirror reflection on the detection area in the optical imaging system; and
placing the optical imaging system, the first illumination device, and the second illumination device in an optical device housing.

12. The method according to claim 11, wherein the focusing element is arranged in such a way that the focusing element has an image distance equal to a distance between the focusing element and the detection area plus a distance between the detection area and the optical imaging system.

13. The method according to claim 11, wherein the punctiform light source is a monochromatic light diode.

14. The method according to claim 11, wherein the punctiform light source comprises a light element and an aperture with a light exit opening.

15. The method according to claim 11, wherein the focusing element is a condenser lens.

16. The method according to claim 11, wherein the focusing element is a concave mirror strip.

17. The method according to claim 16, wherein the light source of the first illumination device and the punctiform light source of the second illumination device are combined into one unit.

18. The method according to claim 11, wherein the light source in the first illumination device comprises a plurality of light elements of different wavelength, the light elements capable of being individually activated.
